(19) United States
(12) Patent Application Publication
(10) Pub. No.: US 2023/0167032 A1
(43) Pub. Date: Jun. 1, 2023

(54) Compositions and Methods for Improved Carbonation Curing of Concrete

(71) Applicant: LIXIVIA, INC., Santa Barbara, CA (US)

(72) Inventor: Michael D Wyrsta, Santa Barbara, CA (US)

(21) Appl. No.: 17/982,757

(22) Filed: Nov. 8, 2022

Related U.S. Application Data
(60) Provisional application No. 63/281,535, filed on Nov. 19, 2021.

(51) Int. Cl. C04B 40/02; C04B 14/28

(52) U.S. Cl. CPC C04B 40/0231; C04B 14/28; C04B 2111/00017

(57) ABSTRACT

Compositions and methods for carbonation curing of cement and/or concrete are provided, where a lixiviant species that solubilizes calcium from oxides and silicates provided with the cement or concrete is included in the curing cement or concrete mixture. Reaction of solubilized calcium with carbon dioxide results in the formation of insoluble calcium carbonate that is incorporated into the structure of the cured cement or concrete, and simultaneously regenerates the lixiviant species. Rapid reaction of carbon dioxide within the curing cement or concrete further generates a concentration gradient that accelerates uptake of additional carbon dioxide, for example from ambient air. This incorporation of environmental carbon also causes the cured cement or concrete to be used for long term carbon sequestration.

This application claims the benefit of Unite States Provisional Patent Application Serial No. 63/281,535 filed on Nov. 19, 2021. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is curing of concrete via carbonation.

### BACKGROUND

The background description includes information that may be useful in understanding the present invention. It is not an admission that any of the information provided herein is prior art or relevant to the presently claimed invention, or that any publication specifically or implicitly referenced is prior art.

Concrete is a nearly ubiquitous material used in a wide variety of structures and structural elements. In its simplest form it can be thought of as a composite of an aggregate material held together by materials formed in the reaction of a binding agent (such as a cement) with water. Production of materials used in concrete (particularly Portland cement), however, is a significant contributor to emission of carbon dioxide (CO₂), a significant greenhouse gas. Some of these CO₂ emissions are produced to support energy-intensive processes used in producing cements from naturally occurring raw materials, which typically involves a high-temperature roasting process that converts calcium carbonates to calcium oxides. In addition, the conversion of calcium carbonate to calcium oxide releases large quantities of CO₂.

One approach to reducing the impact of CO₂ production associated with concrete materials is sequestration of CO₂ within the concrete itself, via carbonation. Carbonation of traditional moisture-cured concrete by reaction of the concrete with atmospheric CO₂ is a well-known phenomenon, and is responsible for the characteristic white bloom that can appear on such materials. Such natural carbonation, however, is associated with increased corrosion of steel rebar incorporated into the moisture cured concrete (via decreased pH and increased chloride penetration) as well as conversion of calcium silicates that serve to bind to components of concrete together to silica gel.

More recently an alternative to traditional moisture curing of concrete has been developed in which CO₂ is deliberately introduced during the early curing process. Such carbonation curing methods produce concrete that does not have the deficiencies of concrete resulting from natural carbonation processes, and can provide concretes with improved compression strength, improved abrasion resistance, and reduced pore size (which reduces chloride penetration and associated corrosion of encased steel). In addition, such carbonation cured concrete can sequester significant amounts of CO₂, up to 15% to 30% by weight of its cement content.

Carbonation curing methods are, however, limited by the relatively low solubility of CO₂ in water. Increasing the solids content of a concrete mixture can help in this regard. This can be done by reducing the amount of water in the initial concrete mixture (at the expense of fluidity) or by introducing a pre-curing step that removes water from a molded concrete object by evaporation prior to application of CO₂. Such approaches, however, greatly restrict the uses to which carbonation cured concrete can be applied.

Another approach that is commonly used to improve CO₂ uptake in carbonation curing of concrete is the use of high purity CO₂, often applied at high pressure within a sealed vessel. Such approaches, however, require highly specialized equipment and greatly restrict the range of uses for carbonation cured concrete materials.

Thus, there is still a need for a simple and effective method to implement carbonation curing of concrete materials.

### SUMMARY OF THE INVENTION

The inventive subject matter provides apparatus, systems and methods in which a lixiviant compound is introduced into a concrete mixture in order to improve (e.g., accelerate) curing of the resulting lixiviant concrete mixture on exposure to carbon dioxide. The lixiviant acts to release calcium from calcium-containing silicates of the concrete mixture for utilization in the curing reaction. Such methods can be utilized to sequester carbon dioxide as calcium carbonate within the resulting cured concrete.

Among embodiments of the inventive concept are methods of carbonation curing concrete by adding a lixiviant (such as an amine or amine-containing compound) to a concrete mixture that includes a calcium-containing cement to generate a lixiviant concrete mixture. This lixiviant concrete mixture is then exposed to carbon dioxide, such as a gas mixture that includes carbon dioxide. In such embodiments the gas mixture can be applied at ambient pressure or greater than ambient pressure. Suitable gas mixtures include air, flue gas, and a gaseous waste stream comprising carbon dioxide. In some embodiments the lixiviant is provided in a substoichiometric quantity relative to calcium content of the concrete mixture. In some embodiments the concrete mixture includes a filler, which can also include calcium.

Other embodiments of the inventive concept include compositions for facilitating carbonation curing of concrete Such compositions include a cement suitable for forming concrete and that includes calcium, and also include an amine. The amine can be an organic amine, and can be present in a substoichiometric quantity relative to calcium content of the cement. Such a composition can be provided as a dry mixture. In other embodiments the composition can be provided in combination with water as a suspension, slurry, or paste.

Among embodiments of the inventive concept are methods of sequestering carbon dioxide within cured concrete by adding a lixiviant (such as an amine or amine-containing compound) to a concrete mixture that includes a calcium-containing cement to generate a lixiviant concrete mixture. This lixiviant concrete mixture is then exposed to carbon dioxide, such as a gas mixture that includes carbon dioxide. In such embodiments the gas mixture can be applied at ambient pressure or greater than ambient pressure. Suitable gas mixtures include air, flue gas, and a gaseous waste stream comprising carbon dioxide. In some embodiments the lixiviant is provided in a substoichiometric quantity relative to calcium content of the concrete mixture. In some embodiments the concrete mixture includes a filler, which can also include calcium.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 schematically depicts an exemplary process for carbonation curing of a cement and/or concrete mixture by a method of the inventive concept.

FIG. 2 schematically depicts an exemplary process for long term sequestration of carbon (in this instance from atmospheric carbon dioxide) in a cured cement and/or concrete mixture by a method of the inventive concept.

### DETAILED DESCRIPTION

The inventive subject matter provides apparatus, systems and methods in which a lixiviant is introduced in a concrete mixture that includes aggregate and a cement that reacts to fix the aggregate. The lixiviant facilitates release of reactive calcium ions from CaSiO3, calcium silicates, calcium aluminum silicates, CaO and/or Ca(OH)2 and other related minerals and/or calcium containing solids (e.g., cement, aggregate, filler) into solution. Reaction with CO₂ gas generates calcium carbonate, which contributes to binding of aggregate materials within the curing concrete, while generating a concentration gradient that increases uptake of CO₂. Formation of calcium carbonate within the curing material regenerates the lixiviant species, so that it acts as a catalyst for concrete carbonation, and can be provided in sub-stoichiometric amounts relative to the calcium content of the concrete mixture.

The following description includes information that may be useful in understanding the present invention. It is not an admission that any of the information provided herein is prior art or relevant to the presently claimed invention, or that any publication specifically or implicitly referenced is prior art.

Within the context of this application the term “environmental carbon” is understood to refer to carbon that is endogenous to the environment present at or near cements and/or concretes of the inventive concept as they undergo a curing process. Examples of environmental carbon include carbon embodied as the carbon dioxide content of air, waste gases from combustion, and/or gaseous products of microbial action (e.g., fermentation gases, gases from decomposition of biomass, etc.) that come into contact with cements and/or concretes of the inventive concept as they are curing.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

One should appreciate that the disclosed methods provide many advantageous technical effects including sequestration of a greenhouse gas while also providing concrete with improved performance characteristics.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

Typical concrete starts as a mixture of cement (e.g., Portland cement), which includes a mixture of calcium silicates, with a divided aggregate material (e.g., sand and/or gravel). Portland cement is typically made by roasting limestone in a high temperature kiln, a fuel intensive process that generates CO₂ both by burning fuel and the release of CO2 from limestone during the roasting process. After sizing, cement is mixed with a relatively non-reactive aggregate material. Concrete is formed following the addition of water. In a typical moisture cured concrete the following hydration reaction between water and tricalcium silicates present in the cement takes place:

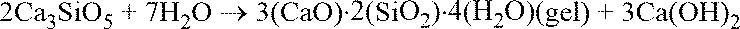

A similar reaction with slightly different stoichiometry takes place with dicalcium silicates present in the cement. Portland cement is a complex mixture that includes 5% to 50% of five major calcium silicates and aluminates. All of these undergo hydration reactions that contribute to the final concrete material’s physical properties. As these reactions proceed the reaction products of the cement gradually bond sand, gravel, and other components of the concrete mixture together, thereby forming a solid mass.

Carbonation curing is an accelerated curing process in which CO₂ gas is introduced to the curing concrete mixture. This results in the formation of calcium carbonate within the concrete by the following reactions:

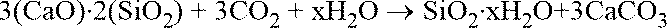

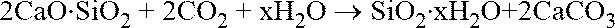

Carbonation curing is an exothermic reaction, and as a result concrete so produced can solidify at a much faster rate than by conventional moisture curing. As shown products of the carbonation reaction are primarily calcium carbonate and silica gel, and can capture large amounts of CO₂ (in the form of calcium carbonate) relative to the cement component of the concrete. The resulting concrete products can show improved performance relative to moisture cured concrete in regard to strength, durability, and dimensional stability, due at least in part to the depletion of calcium hydroxide.

Unfortunately, due to the relatively low solubility of CO₂ in water, carbonation curing typically requires the addition of a carbonate (e.g., in the form of calcium carbonate) at high concentrations (in excess of 50% w/v) and/or application of CO₂ in a sealed chamber at elevated pressures. These process limitations severely limit the application of carbonation curing.

In methods of the inventive concept a lixiviant compound is provided in the concrete mixture that acts to release calcium ions from insoluble calcium hydroxides and calcium oxides (which react with water to form calcium hydroxides) for reaction with CO₂ to form additional calcium carbonate. Rapid depletion of solvated CO₂ drives a concentration gradient that markedly increases CO₂ uptake by the curing concrete mixture, allowing effective carbonation curing at lower to atmospheric CO₂ concentrations and/or at low to ambient pressure.

Reaction with CO₂ also regenerates the lixiviant compound, permitting further reaction with insoluble calcium oxides and hydroxides. In this sense the lixiviant essentially acts as a catalyst for carbonation curing, and can be used at substoichiometric concentrations in the concrete mixture relative to the available calcium content present in the cement component. It should also be appreciated that such lixiviant compounds can liberate calcium from other components of the concrete mixture including aggregate materials, rubble and/or fillers (e.g., steel slag, fly ash, etc.).

In preferred embodiments of the inventive concept the lixiviant is an organic or inorganic amine. Lixiviant can be provided in compositions and/or utilized in methods of the inventive concepts at a concentration of from 0.001%, 0.01%, 0.1%, 0.3%, 1%, 2.5%, 5%, 7.5%, 10%, 12.5%, 15%, 17.5%, 20%, 22.5%, 25%, 27.5%, or 30% by weight relative to cement content in a concrete mixture, or any concentration or concentration range between two of these values. In some embodiments the amount of lixiviant utilized in compositions and/or methods of the inventive concept is a substoichiometric amount relative to calcium content of cement, aggregate, and/or filler of a concrete or concrete curing method of the inventive concept. In some embodiments the amount of lixiviant utilized in compositions and/or methods of the inventive concept is a stoichiometric amount relative to calcium content of cement, aggregate, and/or filler of a concrete or concrete curing method of the inventive concept. In some embodiments the amount of lixiviant utilized in compositions and/or methods of the inventive concept is a superstoichiometric amount (i.e., in excess of that required by stoichiometry) relative to calcium content of cement, aggregate, and/or filler of a concrete or concrete curing method of the inventive concept.

Suitable organic amines can have the general formula shown in Compound 1, where N is nitrogen, H is hydrogen, R1 to R3 can be an organic (i.e., carbon-containing) group or H, and X is a counterion (i.e., a counter anion).

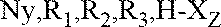

Suitable counterions can be any form or combination of atoms or molecules that produce the effect of a negative charge. Such counterions can be provided with the lixiviant. Alternatively, in some embodiments a lixiviant species can be provided without a counterion. In such embodiments the counterion can be provided from components of the concrete mixture (e.g., carbonate and/or bicarbonate). Suitable counterions include (but are not limited to) carbonate, bicarbonate, a halide (for example fluoride, chloride, bromide, and iodide), an anion derived from a mineral acid (for example nitrate, phosphate, bisulfate, sulfate, silicate), an anion derived from an organic acids (for example carboxylate, citrate, malate, acetate, thioacetate, propionate and lactate), an organic molecules or biomolecule (for example a protein or peptide, amino acid, nucleic acid, and fatty acid), and others (for example zwitterions and basic synthetic polymers). For example, monoethanolamine hydrochloride (MEA·HCl, HOC₂H₄NH₃Cl) conforms to Compound 1 as follows: one nitrogen atom (N₁) is bound to one carbon atom (R₁ = C₂H₅O) and 3 hydrogen atoms (R₂, R₃ and H), and there is one chloride counteranion (X₁ = C1-). Compounds having the general formula shown in Compound 1 can have a wide range of acidities, and an organic amine of the inventive concept can be selected on the basis of its acidity so that it can selectively react with calcium salts or oxides in the concrete mixture.

Equation 4 depicts a primary chemical reaction in extracting calcium from calcium hydroxide from a matrix using an organic amine cation (OA-H+)/counterion (Cl-) complex (OA-H+/Cl-) as a lixiviant. Suitable sources of calcium hydroxide include hydroxides present in cement, filler, and/or aggregate utilized in a concrete mixture, calcium hydroxide generated by reaction of calcium oxide present in cement, filler, and/or aggregate utilized in a concrete mixture, calcium hydroxide generated during a curing portion of the curing process as shown in Equation 1, and hydrolysis of calcium oxide generated during a curing process as shown in Equation 2 and Equation 3 . Note that the OA-H+/Cl- complex dissociates in water into OA-H+ and Cl-.

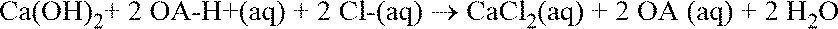

The counterion (Cl-) is transferred from the organic amine cation (OA-H+) to the calcium hydroxide to form a soluble calcium/counterion complex (CaCl₂), uncharged organic amine (OA), and water.

The calcium/counterion complex can, in turn, react with solubilized carbon dioxide (i.e., carbonic acid) to generate calcium carbonate and regenerate the lixiviant species, as shown in Equation 5.

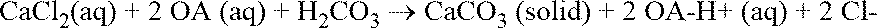

This regeneration of the charged lixiviant species allows it to act as a catalyst, permitting the use of small quantities of the lixiviant relative to calcium available in the concrete mixture. Withdrawal of CO₂ in solution (H₂CO₃) also generates a concentration gradient that drives additional uptake of CO₂ by the curing concrete as the reaction progresses.

Organic amines suitable for the extraction of alkaline earth elements (for example from calcium containing or, steel slag, and other materials) can have a pKa of about 7 or about 8 to about 14, and can include protonated ammonium salts (i.e., not quaternary). Examples of suitable organic amines for use in lixiviants include weak bases such as ammonia, nitrogen containing organic compounds (for example monoethanolamine, diethanolamine, triethanolamine, morpholine, ethylene diamine, diethylenetriamine, triethylenetetramine, methylamine, ethylamine, propylamine, dipropylamines, butylamines, diaminopropane, triethylamine, dimethylamine, and trimethylamine), low molecular weight biological molecules (for example glucosamine, amino sugars, tetraethylenepentamine, amino acids, polyethyleneimine, spermidine, spermine, putrescine, cadaverine, hexamethylenediamine, tetraethylmethylenediamine, polyethyleneamine, cathine, isopropylamine, and a cationic lipid), biomolecule polymers (for example chitosan, polylysine, polyornithine, polyarginine, a cationic protein or peptide), and others (for example a dendritic polyamine, a polycationic polymeric or oligomeric material, and a cationic lipid-like material), or combinations of these. In some embodiments of the inventive concept the organic amine can be monoethanolamine, diethanolamine, or triethanolamine, which in cationic form can be paired with nitrate, bromide, chloride or acetate anions. In other embodiments of the inventive concept the organic amine can be lysine or glycine, which in cationic form can be paired with chloride or acetate anions. In a preferred embodiment of the inventive concept the organic amine is monoethanolamine, which in cationic form can be paired with a chlorine anion.

Such organic amines can range in purity from about 50% to about 100%. For example, an organic amine of the inventive concept can have a purity of about 50%, about 55%, about 60%, about 65%, about 70%, about 75%, about 80%, about 85%, about 90%, about 95%, about 97%, about 99%, or about 100%. In a preferred embodiment of the inventive concept the organic amine is supplied at a purity of about 90% to about 100%. It should be appreciated that organic amines can differ in their ability to interact with different members of the alkaline earth family and with contaminating species, and that such selectivity can be utilized in the recovery of multiple alkaline earths as described below.

Inventors further contemplate that zwitterionic species can be used in suitable lixiviants, and that such zwitterionic species can form cation/counterion pairs with two members of the same or of different molecular species. Examples include amine containing acids (for example amino acids and 3-aminopropanoic acid), chelating agents (for example ethylenediaminetetraacetic acid and salts thereof, ethylene glycol tetraacetic acid and salts thereof, diethylene triamine pentaacetic acid and salts thereof, and 1,2-bis(o-aminophenoxy)ethane-N,N,N′,N′-tetraacetic acid and salts thereof), and others (for example betaines, ylides, and polyaminocarboxylic acids).

Organic amines for use in lixiviants can be selected to have minimal environmental impact. The use of biologically derived organic amines, such as glycine, is a sustainable practice and has the beneficial effect of making processes of the inventive concept more environmentally sound. In addition, it should be appreciated that some organic amines, such as monoethanolamine, have a very low tendency to volatilize during processing. In some embodiments of the inventive concept an organic amine can be a low volatility organic amine (i.e., having a vapor pressure less than or equal to about 1% that of ammonia under process conditions). In preferred embodiments of the inventive concept the organic amine is a non-volatile organic amine (i.e., having a vapor pressure less than or equal to about 0.1% that of ammonia under process conditions). Capture and control of such low volatility and non-volatile organic amines requires relatively little energy and can utilize simple equipment. This reduces the likelihood of such low volatility and non-volatile organic amines escaping into the atmosphere and advantageously reduces the environmental impact of their use.

Embodiments of the inventive concept include a cement suitable for mixing with aggregate to form a concrete mixture or a concrete mixture (e.g., cement with aggregate and/or filler). Such a cement mixture or concrete mixture can include an insoluble source of calcium (e.g., calcium oxide, calcium hydroxide, and/or a calcium silicate) and a lixiviant that can solubilize calcium from such a source. The lixiviant can be present in sub-stoichiometric, stoichiometric, or superstoichiometric amounts relative to calcium content of the cement mixture. In preferred embodiment substoichiometric amounts of the lixiviant species relative to calcium content of the cement mixture are provided. For example, the lixiviant compound can be present at from 0.001X, 0.01X, 0.03X, 0.1X, 0.25X, 0.5X 0.75X, 0.9X, 0.95X, 0.99X, or less than 1X the amount of calcium provided in the cement mixture. Similarly, lixiviant can be provided at from 0.001%, 0.01%, 0.03%, 0.1%, 0.3%, 1%, 3%, 10%, 20%, 30%, 40%, or up to about 50% of the cement mixture by weight. In some embodiments the lixiviant can be present in equimolar or supramolar amounts relative to calcium content of the cement mixture.

In some embodiments the lixiviant can be provided as a dry compound provided in combination with other dry components of the cement mixture or concrete mixture. In other embodiments the lixiviant can be added to dry components of the cement mixture or concrete mixture following or in combination with the addition of water.

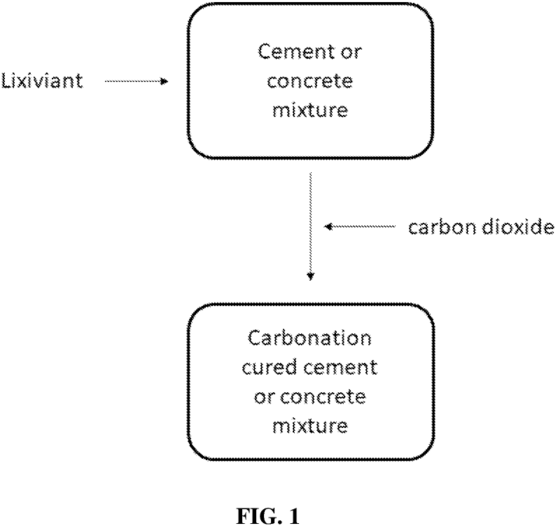

Embodiments of the inventive concept include methods for improved carbonation curing of cement mixtures or of concrete mixtures incorporating cement (e.g., cement in combination with aggregate and/or filler) by inclusion of a lixiviant into such a cement or concrete mixture prior to or during the curing process. An example of such a method is shown in FIG. 1. As shown, a cement or concrete mixture that includes calcium in an insoluble form (e.g., calcium oxide, calcium hydroxide, calcium-containing silicates, etc.) is mixed with a lixiviant selected to extract calcium from such insoluble forms as a soluble calcium salt (e.g., calcium chloride). The lixiviant serves to solvate calcium from calcium containing oxides, hydroxides, and/or silicates present in the cement mixture and/or in cement, aggregate, and/or filler of the concrete mixture. As shown, the resulting solvated calcium is reactive with carbon dioxide during the curing process, generating insoluble calcium carbonate that contributes to the structure of the resulting carbonation cured cement or concrete. This carbonation reaction reduces content of solubilized carbon dioxide in the curing cement or concrete, providing a concentration gradient that drives incorporation of additional carbon dioxide. This effect offsets or at least partially offsets issues with solubility of carbon dioxide in cement mixtures and concrete mixtures that have reduced the utility of prior art carbonation curing methods.

This carbonation reaction further regenerates the lixiviant that is incorporated into the cement mixture or concrete mixture, permitting the lixiviant to act as a pseudo-catalyst for carbonation curing of cement and/or concrete. This reduces the amount of lixiviant that necessary for performing the method. In preferred embodiments, lixiviant is incorporated into the cement mixture and/or concrete mixture in an amount that is substoichiometric relative to the amount of calcium present in the cement mixture or the concrete mixture (i.e., calcium content cement component, aggregate component, and/or filler component). For example, the lixiviant compound can be present at from 0.001X, 0.01X, 0.03X, 0.1X, 0.25X, 0.5X 0.75X, 0.9X, 0.95X, 0.99X, or less than 1X the amount of calcium provided in the cement mixture or concrete mixture. Similarly, lixiviant can be provided at from 0.001%, 0.01%, 0.03%, 0.1%, 0.3%, 1%, 3%, 10%, 20%, 30%, 40%, or up to about 50% of the cement mixture or concrete mixture by weight.

In such methods a lixiviant can be provided as part of a dry cement mixture or dry concrete mixture, with curing activated by the addition of water. In other embodiments water can be added to a dry cement or concrete mixture, followed by addition of the lixiviant and incorporation by mixing. In such embodiments the cement mixture or concrete mixture can be partially cured by conventional methods prior to the addition of lixiviant and the resulting initiation of carbonation curing.

As noted above, methods of the inventive concept utilize a source of carbon dioxide to both form insoluble calcium carbonates from calcium brought into solution by a lixiviant in the cement mixture or concrete mixture and also to regenerate the lixiviant species (thereby permitting further solvation of calcium). Suitable sources of carbon dioxide include carbon dioxide containing gases, carbon dioxide containing solutions (e.g., carbonated liquids, solutions containing soluble carbonates and/or bicarbonates), and soluble carbonate and/or bicarbonate salts. Suitable carbon dioxide containing gases include ambient untreated air, exhaust gases, flue gases, air enriched in carbon dioxide (e.g., through addition of purified or partially purified carbon dioxide, through selective removal of a non-carbon dioxide component gas such as oxygen and/or nitrogen), and/or purified or partially purified carbon dioxide. Such carbon dioxide containing gases can be provided at atmospheric pressure or at elevated (i.e., greater than atmospheric pressure). Solid carbonate and/or bicarbonate salts can be incorporated into dry cement mixtures and/or dry concrete mixtures. Alternatively, solid carbonate and/or bicarbonate salts can be added to a cement mixture or concrete mixture following the addition of water. Similarly, aqueous solutions of soluble carbonate and/or bicarbonate salts can be added to a dry cement or dry concrete mixture as a component of the initial water used for initial hydration, or can be added following initial hydration of the cement mixture or concrete mixture.

In some embodiments a combination of sources of carbon dioxide may be used, for example a combination of two or more of a carbon dioxide containing gas, a carbon dioxide containing liquid, and/or a carbon dioxide containing solid (e.g., a carbonate and/or bicarbonate salt) can be used. For example, a dry cement mixture or dry concrete mixture can be provided with an inactive form of lixiviant (e.g., a free base form) and a carbonate and/or bicarbonate salt, such that on the addition of water carbonation curing is initiated throughout the bulk of the cement mixture or concrete mixture following in situ generation of active lixiviant (e.g., a chloride salt of an amine or organic amine lixiviant) that is further supported by incorporation of carbon dioxide from a carbon dioxide containing gas (e.g., ambient untreated air).

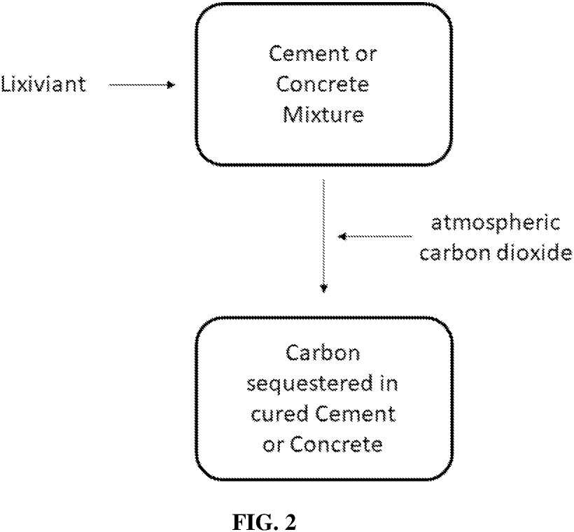

Other embodiments of the inventive concept include methods of sequestering carbon. Current methods for carbon sequestration, such as incorporation into biomass through cultivation of plants or algae, fail to provide long term sequestration. Bacterial, fungal, and other biological sources of decomposition of the products of such methods quickly release carbon fixed in biomass back into the atmosphere (e.g., as carbon dioxide, methane, etc.), reducing the overall effectiveness of such approaches. Some embodiments of the inventive concept provide long term carbon sequestration by incorporation of a calcium-extracting lixiviant in a concrete mixtures incorporating cement (e.g., cement in combination with aggregate and/or filler) by inclusion of a lixiviant into such a cement or concrete mixture prior to or during the curing process, as shown in FIG. 2. The lixiviant serves to solvate calcium from calcium containing oxides, hydroxides, and/or silicates present in the cement mixture and/or in cement, aggregate, and/or filler of the concrete mixture. Such solvated calcium is reactive with carbon dioxide (e.g., atmospheric carbon dioxide, as shown in FIG. 2) during the curing process, generating insoluble calcium carbonate that contributes to the structure of the resulting cured cement or concrete. This carbonation reaction reduces content of solubilized carbon dioxide in the curing cement or concrete, providing a concentration gradient that drives incorporation of additional carbon dioxide, causing the curing cement mixture or concrete mixture to act as a carbon sink. This effect offsets or at least partially offsets issues with solubility of carbon dioxide in cement mixtures and concrete mixtures that have reduced the utility of prior art carbonation curing methods.

Cement and/or concrete articles so produced are not readily subject to biological decomposition and can provide long term (e.g., greater than 5, 10, 25, 50 75, 100, 250, 500, 750, or 1,000 or more years) sequestration of carbon in the form of insoluble or poorly soluble carbonates within such cement and/or concrete articles. Such articles can incorporate from 1%, 2.5%, 5%, 7.5%, 10% 12.5%, 15%, 17.5%, 20%, 22.5% 25%, 27.5%, 30% or more by weight as insoluble or poorly soluble carbonate salts (e.g., calcium carbonate) where the carbon component is sequestered carbon (i.e., derived from carbon present in the environment during curing of the cement mixture of concrete mixture, such as carbon dioxide).

In such carbon sequestration methods, the carbonation reaction further regenerates the lixiviant that is incorporated into the cement mixture or concrete mixture, permitting the lixiviant to act as a pseudo-catalyst for carbonation curing of cement and/or concrete. This reduces the amount of lixiviant that necessary for performing the method. In preferred embodiments, lixiviant is incorporated into the cement mixture and/or concrete mixture in an amount that is substoichiometric relative to the amount of calcium present in the cement mixture or the concrete mixture (i.e., calcium content cement component, aggregate component, and/or filler component). For example, the lixiviant compound can be present at from 0.001X, 0.01X, 0.03X, 0.1X, 0.25X, 0.5X 0.75X, 0.9X, 0.95X, 0.99X, or less than 1X the amount of calcium provided in the cement mixture or concrete mixture. Similarly, lixiviant can be provided at from 0.001%, 0.01%, 0.03%, 0.1%, 0.3%, 1%, 3%, 10%, 20%, 30%, 40%, or up to about 50% of the cement mixture or concrete mixture by weight.

In such methods a lixiviant can be provided as part of a dry cement mixture or dry concrete mixture, with curing activated by the addition of water. In other embodiments water can be added to a dry cement or concrete mixture, followed by addition of the lixiviant and incorporation by mixing. In such embodiments the cement mixture or concrete mixture can be partially cured by conventional methods prior to the addition of lixiviant and the resulting initiation of carbonation curing.

As noted above, carbon sequestration methods of the inventive concept capture carbon in the form of a source of carbon dioxide in reactions that both form insoluble calcium carbonates from calcium brought into solution by a lixiviant in the cement mixture or concrete mixture and also to regenerate the lixiviant species (thereby permitting further solvation of calcium). Suitable sources of carbon dioxide include carbon dioxide containing gases, carbon dioxide containing solutions (e.g., carbonated liquids, solutions containing soluble carbonates and/or bicarbonates), and soluble carbonate and/or bicarbonate salts. Suitable carbon dioxide containing gases include ambient untreated air, exhaust gases, flue gases, air enriched in carbon dioxide (e.g., through addition of purified or partially purified carbon dioxide, through selective removal of a non-carbon dioxide component gas such as oxygen and/or nitrogen), and/or purified or partially purified carbon dioxide. Such carbon dioxide containing gases can be provided at atmospheric pressure or at elevated (i.e., greater than atmospheric pressure). Solid carbonate and/or bicarbonate salts can be incorporated into dry cement mixtures and/or dry concrete mixtures. Alternatively, solid carbonate and/or bicarbonate salts can be added to a cement mixture or concrete mixture following the addition of water. Similarly, aqueous solutions of soluble carbonate and/or bicarbonate salts can be added to a dry cement or dry concrete mixture as a component of the initial water used for initial hydration, or can be added following initial hydration of the cement mixture or concrete mixture.

In some embodiments a combination of sources of carbon dioxide may be used, for example a combination of two or more of a carbon dioxide containing gas, a carbon dioxide containing liquid, and/or a carbon dioxide containing solid (e.g., a carbonate and/or bicarbonate salt) can be used. For example, a dry cement mixture or dry concrete mixture can be provided with an inactive form of lixiviant (e.g., a free base form) and a carbonate and/or bicarbonate salt, such that on the addition of water carbonation curing is initiated throughout the bulk of the cement mixture or concrete mixture following in situ generation of active lixiviant (e.g., a chloride salt of an amine or organic amine lixiviant) that is further supported by incorporation of carbon dioxide from a carbon dioxide containing gas (e.g., ambient untreated air).

In preferred embodiments of carbon sequestration methods of the inventive concept the source of carbon dioxide is a carbon dioxide containing gas, such as ambient air, carbon dioxide enriched ambient air, an exhaust gas, gaseous products of fermentation processes (e.g., ethanol production, brewing of alcoholic beverages), gaseous products of decomposition (e.g., of biomass) and/or a flue gas. Accordingly, such carbon sequestration methods can be coupled with manufacturing processes that generate carbon dioxide containing exhaust gases, such as combustion of fossil fuels to generate power, steel manufacture, and/or smelting operations.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C .... and N, the text should be interpreted as requiring only one element from the group, not A plus N, or B plus N, etc.

What is claimed is:

1. A method of carbonation curing concrete, comprising:
adding a lixiviant to a concrete mixture comprising a calcium to generate a lixiviant concrete mixture: and
exposing the lixiviant concrete mixture to carbon dioxide.

2. The method of claim 1, wherein the lixiviant comprises an amine.

3. The method of claim 1, wherein the lixiviant is provided in a substoichiometric quantity relative to calcium content of the concrete mixture.

4. The method of claim 1, wherein carbon dioxide is applied at ambient pressure or greater than ambient pressure.

5. The method of claim 1, wherein carbon dioxide is applied as a gas mixture.

6. The method of claim 5, wherein the gas mixture is selected from the group consisting of air, flue gas, and a gaseous waste stream comprising carbon dioxide.

7. The method of claim 1, wherein the concrete mixture comprises a filler, and wherein the filler comprises calcium.

8. A composition for facilitating carbonation curing of concrete, comprising:
a cement suitable for forming concrete and comprising calcium; and
a lixiviant.

9. The composition of claim 8, wherein the lixiviant comprises an amine.

10. The composition of claim 8, wherein the lixiviant is present in a substoichiometric quantity relative to calcium content of the cement.

11. The composition of claim 8, wherein the composition is provided as a dry mixture.

12. The composition of claim 8, wherein the composition is provided in combination with water as a suspension, slurry, or paste.

13. A method of long term sequestration of carbon, comprising:
adding a lixiviant to a cement or concrete mixture comprising calcium to generate a lixiviant concrete mixture: and
exposing the lixiviant concrete mixture to a source of carbon dioxide comprising environmental carbon to form a carbonate cured cement or carbonate cured concrete incorporating environmental carbon as calcium carbonate, wherein the source of carbon dioxide comprises environmental carbon.

14. The method of claim 13, wherein the lixiviant comprises an amine.

15. The method of claim 13, wherein carbon dioxide is applied as a carbon dioxide containing gas at ambient pressure or greater than ambient pressure.

16. The method of claim 15, wherein the carbon dioxide containing gas is selected from the group consisting of air, a flue gas, a gas produced during fermentation, a gas produced by decomposition, and a gaseous waste stream comprising carbon dioxide.

17. The method of claim 13, wherein the cement or concrete mixture comprises a filler, and wherein the filler comprises calcium.
